(19) United States
(12) Patent Application Publication
(10) Pub. No.: US 2012/0029888 A1
(43) Pub. Date: Feb. 2, 2012

(54) TOPOGRAPHY SHAPING APPARATUS FOR FORMING SURFACES OF LOW FRICTION COEFFICIENT

(76) Inventors: Jeng-Haur HORNG, Yunlin County (TW); Chin-Chung Wei, Yunlin County (TW); Cheng-Han Wu, Yunlin County (TW); Wei-Shun Hsu, Yunlin County (TW); Hsiang-Jung Cheng, Yunlin County (TW); Ya-Hsin Horng, Yunlin County (TW)

(21) Appl. No.: 12/968,912

(22) Filed: Dec. 15, 2010

(30) Foreign Application Priority Data
Jul. 30, 2010 (TW) 099125244

(51) Int. Cl. G06F 17/10

(52) U.S. Cl. 703/2

(57) ABSTRACT

The topography shaping apparatus for forming surfaces of low friction coefficient includes a data-input element, a computing element, and a shaping element. The data-input element is adapted to receive an action length, a fractal dimension value, and a fractal roughness parameter of a desired surface. The computing element connects with the data-input element to obtain a surface topography function from the data received by the data-input element. The shaping element connects with the computing element for processing a target surface to have a sectional outline matching the surface topography function to become the desired surface.

### BACKGROUND OF THE INVENTION

1. Field of the Invention

The invention generally relates to a topography shaping apparatus for forming surfaces of low friction coefficient, and especially to a topography shaping apparatus that initially acquires a surface topography function of a desired surface and forms the surface according to the surface topography function.

2. Description of the Related Art

In the field of surface topography, “fractal dimension” is used to show the degrees of complication and irregularity of an outline, wherein the said fractal dimension corresponds to a degree of self-similarity instead of the roughness of a surface. More specifically, an increasing value of fractal dimension means that the self-similar structure of a surface with low roughness is more complicated than that of another surface with high roughness. Besides, a “fractal roughness parameter” is further introduced as a parameter representing a variation in height of a rough surface, which is relative to the amplitude of the rough surface. Specifically, under a steady fractal dimension, the fractal roughness parameter decreases while the amplitude of the rough surface rises to result in a rougher surface, and the fractal roughness parameter increases while the amplitude of the rough surface falls to result in a flatter surface.

On the other hand, generally, the friction coefficient indicates a ratio of the friction of an interface between two surfaces to the normal force of any one of the surfaces. Furthermore, stiction between objects occurs easily owing to the friction when the scales of these objects are largely decreased. Therefore, whether a surface has low friction coefficient and durability or not has become a fatal factor to micro electrical machine systems (MEMS), bio-medical elements, precision machinery, and miniature storage devices, as well as to power saving and rotation stability. Specifically, in combination with the previous mentioned fractal theory, the friction is mainly due to a direct contact of a rough surface inherently corresponding to values of fractal dimension and fractal roughness parameter. Therefore, how to design and shape a surface with specific topography for the surface to have a low friction coefficient is important for industrial application.

Therefore, a new topography shaping method and an apparatus thereof are needed to provide surfaces with low friction coefficient for miniature machines.

### SUMMARY OF THE INVENTION

The primary objective of this invention is to provide a topography shaping apparatus for forming surfaces that match a specific surface topography function to provide an even and low friction. The topography shaping apparatus for forming surfaces of low friction coefficient includes a data-input element, a computing element, and a shaping element. The data-input element is adapted to receive an action length, a fractal dimension value between 1.1 and 1.3, and a fractal roughness parameter of a desired surface. The computing element connects with the data-input element to calculate a surface topography function from the data received by the data-input element. The shaping element is connected with the computing element for processing a target surface to have a sectional outline matching the surface topography function to become the desired surface, wherein the surface topography function, Z(x)=G^{(D-1)}L^{(2-D)} cos(πx/L), is stored in the computing element, with the G denoting the fractal roughness parameter, the D denoting the fractal dimension value, and the L denoting the action length.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows the structure of a topography shaping apparatus according to a preferable embodiment of the invention.

FIG. 2 shows a schematic structure of a touching face of a desired target surface.

FIG. 3 shows a diagram with curves between a friction coefficient parameter and a fractal dimension value.

### DETAILED DESCRIPTION OF THE INVENTION

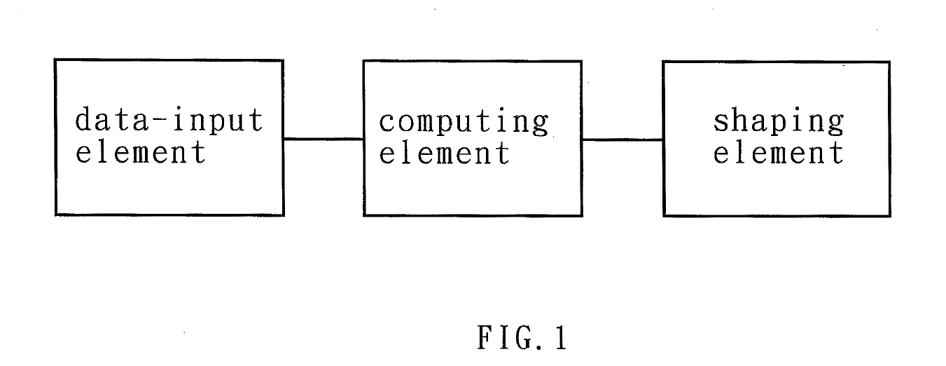

Referring to FIG. 1, the structure of a topography shaping apparatus is shown, which includes a data-input element 1, a computing element 2, and a shaping element 3. The data-input element 1 is used to receive data of a work piece and a desired topography, which can be constructed by a keyboard with or without a length meter. The computing element 2 connects with the data-input element 1 to calculate and obtain a surface topography function from the data received by the data-input element 1. The shaping element 3 connects with the computing element 2 and processes a target surface of the work piece to have a sectional outline matching the surface topography function.

Regarding data inputted into the computing element 2 through the data-input element 1, an action length “L,” a fractal dimension value “D” and a fractal roughness parameter “G” are included. The action length “L” is the length of an action line on the target surface of the work piece, with the action line extending in a direction designed for objects abutting the work piece to move along. The fractal dimension value “D” and fractal roughness parameter “G” are desired characteristic parameters of the target surface of the work piece. Moreover, the computing element 2 obtains the surface topography function “Z(x)” by the following equation:

Z(x)=G^{(D-1)}L^{(2-D)} cos(πx/L) (1),

wherein the “Z(x)” denotes the height at a location that is at a distance of “x” from a start point of the action line.

In detail, the above equation (1) is obtained from a Weierstrass-Mandelbrot fractal function generally used to describe fractal properties of a surface, with this WM function usually shown as

$$Z ( x ) = {G}^{( D - 1 )} {\sum }_{n = {n}_{l}}^{∞} {r}^{- ( 2 - D ) n} cos ( 2 π {r}^{n} x ) . \qquad ( 2 )$$

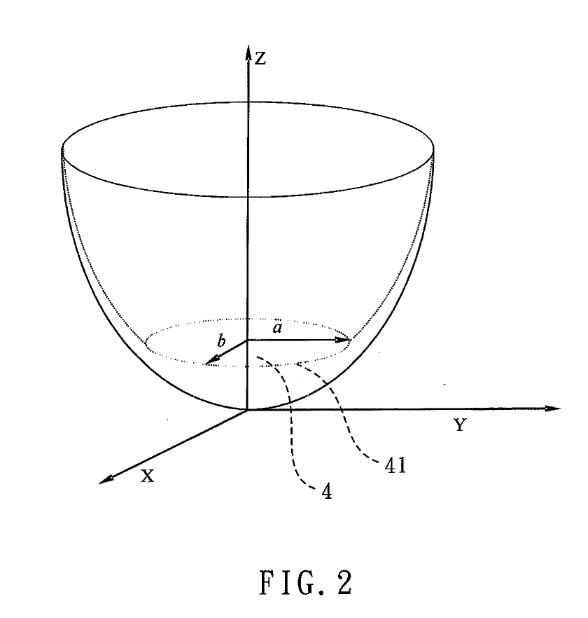

In the WM function, the “r” denotes the ellipticity of an ellipse 41 representing the outline of a touching face 4 of the processed target surface, with the touching face being formed by the pressure of objects abutting and deforming the processed target surface, as shown in FIG. 2. Besides, the “nₗ” denotes the ordinal number of a lowest cut-off frequency, wherein a relationship between the ellipticity “r,” ordinal number “nₗ,” and action length “L” can be shown as the following equation (3):

rⁿ^{ₗ}=L (3).

Accordingly, the equation (1) can be obtained by the equations (2) and (3). Please note that, by references such as “Fractal Theory in Tribology” published on April, 2005 with the international standard book number of 9787111160144/7111160142, the above equations (2) and (3) are accessible.

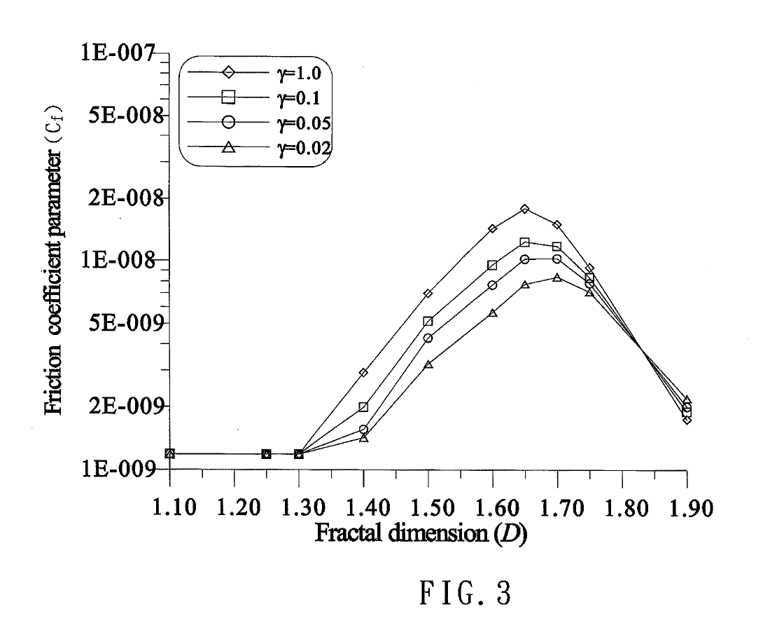

Furthermore, please refer to FIG. 3, which illustrates curves between a friction coefficient parameter “C_{f}” and the fractal dimension value “D.” In accordance with the Amontons' law of friction, the friction coefficient “f” can be shown as:

f=F_{f}/F_{N} (4),

with the “F_{f}” and “F_{N}” representing the friction and an external load, respectively, wherein the friction “F_{f}” can be further shown as

F_{f}=τAᵣ (5),

while the external load “F_{N}” can be further shown as

F_{N}=F_{con}−F_{adh} (6).

In the above equations (5) and (6), the “τ” represents the shearing force; the “Aᵣ” represents the actual contact area in the viewpoint of fractal geometry, which is a total of the area of at least one said touching face; the “F_{con}” represents the total of an external force; and the “F_{adh}” represents an adhesive force of the processed target surface. Specifically, according to equations (5) and (6), the following equation (7) is obtained:

C_{f}=f/τ=Aᵣ/(F_{con}−F_{adh}) (7).

Through the above equation (7) and an analysis of fractal contact area, the result curves shown in FIG. 3 with the fractal roughness parameter “G” being previously determined as 5E-10 are obtained, wherein the fractal roughness parameter “G” is preferably selected from a value between 5E-9 to 1E-10. Through FIG. 3, it is summarized that there is a relatively low-laying section of these curves in a range of the fractal dimension value “D” between 1.1 to 1.3, whether the value of the ellipticity “r” is equal to 1 or much lower, wherein the low-laying section corresponds to a low value of friction coefficient “f”.

Referring FIG. 1 again, the shaping element 3 electrically connected with the computing element 2 processes the target surface of the work piece so as to form the processed target surface with a sectional outline matching the surface topography function “Z(x)” along the action line. Preferably, the shaping element 3 is a CNC carving machine.

As stated above, a processed surface with a pre-designed and low friction coefficient can be easily obtained by inputting the action length “L,” fractal dimension value “D” and fractal roughness parameter “G” into the presented topography shaping apparatus. Moreover, a work piece with this processed surface can be selected from members of micro electrical machine systems (MEMS), bio-medical elements, precision machinery, or miniature storage devices, so that the presented topography shaping apparatus can be used for products in various fields.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A topography shaping apparatus for forming surfaces of low friction coefficient, comprising:
a data-input element adapted to receive an action length, a fractal dimension value between 1.1 and 1.3, and a fractal roughness parameter of a desired surface;
a computing element connecting with the data-input element to calculate a surface topography function from the data received by the data-input element; and
a shaping element connecting with the computing element for processing a target surface to have a sectional outline matching the surface topography function to become the desired surface,
wherein the surface topography function, Z(x)=G^{(D-1)}L^{(2-D)} cos(πx/L), is stored in the computing element, with the G denoting the fractal roughness parameter, the D denoting the fractal dimension value, and the L denoting the action length.
